(19) United States
(12) Patent Application Publication
(10) Pub. No.: US 2018/0085715 A1
(43) Pub. Date: Mar. 29, 2018

(54) COMPOSITION FOR MEMBRANE, METHOD OF PREPARING MEMBRANE USING THE SAME, MEMBRANE PREPARED THEREFROM AND APPARATUS FOR PURIFYING WATER

(71) Applicant: LOTTE CHEMICAL CORPORATION, Seoul (KR)

(72) Inventors: Gyeong Mo Lee, Daejeon (KR); Dong Chan Choi, Daejeon (KR); Chang Min Seo, Daejeon (KR)

(73) Assignee: LOTTE CHEMICAL CORPORATION, Seoul (KR)

(21) Appl. No.: 15/717,346

(22) Filed: Sep. 27, 2017

(30) Foreign Application Priority Data
Sep. 27, 2016 (KR) 10-2016-0123926

(51) Int. Cl. B01D 71/34; B01D 71/12; B01D 69/02; B01D 69/08

(52) U.S. Cl. CPC B01D 71/34; B01D 71/12; B01D 69/02; B01D 2325/24; B01D 2325/20; B01D 2325/36; B01D 69/08

(57) ABSTRACT

Disclosed herein is a membrane composition. The membrane composition includes: about 8 wt % to less than about 20 wt % of a vinylidene fluoride polymer resin; more than 60 wt % to about 90 wt % of a solvent; about 0.1 wt % to about 5 wt % of an acetylated methyl cellulose; and about 1 wt % to about 15 wt % of a hydrophilic additive.

### CROSS-REFERENCE TO RELATED APPLICATION

This application claims priority to and the benefit of Korean Patent Application No. 10-2016-0123926, filed on Sep. 27, 2016 in the Korean Intellectual Property Office, the entire disclosure of which is incorporated herein by reference.

### FIELD OF THE INVENTION

The present invention relates to a membrane composition, a method of preparing a membrane using the same, a membrane prepared by the same, and a water treatment apparatus including the same.

### DESCRIPTION OF RELATED ART

With industrial development and population growth, interest in efficient water use and treatment technologies is increasing. Recently, in order to ensure stable water quality, use of various membranes has been increasing in the fields of water treatment, sewage treatment, and seawater desalination. Particularly, lots of research has been made into hollow fiber membranes because of their high surface area per unit volume, less contamination, and ease of cleaning.

A membrane may be formed of various materials. Particularly, a vinylidene fluoride polymer can secure chemical resistance and strength and is thus widely used to prepare a membrane. However, since the vinylidene fluoride polymer is a hydrophobic material, a membrane formed of the vinylidene fluoride polymer has low water permeability.

Various methods for improving water permeability of a membrane have been proposed. However, these methods have a limit in improvement in strength, chemical resistance, and pressure resistance of a membrane.

Therefore, there is a need for a membrane which has good water permeability without deterioration in strength, chemical resistance, and pressure resistance.

### SUMMARY OF THE INVENTION

The present invention provides a membrane which has good properties in terms of both water permeability and mechanical strength, a method of preparing a membrane using the same, a membrane prepared by the same, and a water treatment apparatus including the same.

One aspect of the present invention relates to a membrane composition.

The membrane composition includes: about 8 wt % to less than about 20 wt % of a vinylidene fluoride polymer resin; more than 60 wt % to about 90 wt % of a solvent; about 0.1 wt % to about 5 wt % of acetylated methyl cellulose; and about 1 wt % to about 15 wt % of a hydrophilic additive.

The solvent may include at least one selected from among dimethylacetamide (DMAc), dimethylformamide (DMF), n-methyl-pyrrolidone (NMP), n-octyl-pyrrolidone, n-phenyl-pyrrolidone, dimethyl sulfoxide (DMSO), chloroform, sulfolane, catechol, ethyl lactate, acetone, ethyl acetate, butyl carbitol, monoethanolamine, butyrolactone, diglycolamine, γ-butyrolactone, tetrahydrofuran (THF), methyl formate, diethyl ether, ethyl benzoate, acetonitrile, ethylene glycol, glycerol, dioxane, methylcarbitol, monoethanolamine, pyridine, propylene carbonate, toluene, decane, hexane, xylene, cyclohexane, 1H,1H,9H-perfluoro-1-nonanol, perfluoro-1,2-dimethylcyclobutane, perfluoro-1,2-dimethylcyclohexane, and perfluorohexane.

The hydrophilic additive may include at least one selected from among polyvinylpyrrolidone (PVP), ethylene glycol, polyethylene glycol (PEG), a hydrophilic polymer having at least one (meth)acrylate group, glycerol, polyacrylonitrile (PAN), polyethylene oxide (PEO) and polyvinyl acetate (PVAc).

Another aspect of the present invention relates to a membrane. The membrane is prepared using the membrane composition as set forth above and has a water permeability of about 300 LMH/bar or more and a tensile strength of about 0.25 kgf/fil. or more.

The membrane may be prepared in hollow fiber form.

The membrane may have a void size of less than about 200 μm.

A further aspect of the present invention relates to a water treatment apparatus.

The water treatment apparatus may include the membrane as set forth above.

### BRIEF DESCRIPTION OF DRAWINGS

FIG. 1 is a schematic sectional view of a membrane according to one embodiment of the present invention.

FIG. 2 is an electron micrograph of a membrane of Example 1 of the present invention.

FIG. 3 is an electron micrograph of a membrane of Comparative Example 1.

### DETAILED DESCRIPTION OF THE INVENTION

Hereinafter, embodiments of the present invention will be described in detail.

Descriptions of known functions and constructions which may unnecessarily obscure the subject matter of the present invention will be omitted.

In addition, it will be understood that the terms “includes”, “comprises”, “including” and/or “comprising,” when used in the specification do not preclude the presence or addition of one or more other features, steps, operations, elements, components, and/or groups. As used herein, the singular forms, “a,” “an,” and “the” are intended to include the plural forms as well, unless context clearly indicates otherwise.

It should be understood that a numerical value related to a certain component is construed to include a tolerance range in interpretation of constituent components, unless clearly stated otherwise.

Herein, “X to Y”, used to indicate the range of certain values, refers to “more than or equal to X and less than or equal to Y”.

Membrane Composition

In accordance with one aspect of the present invention, a membrane composition includes about 8 wt % to less than about 20 wt % of a vinylidene fluoride polymer resin, more than about 60 wt % to about 90 wt % of a solvent, about 0.1 wt % to about 5 wt % of acetylated methyl cellulose, and about 1 wt % to about 15 wt % of a hydrophilic additive.

Now, each component of the membrane composition will be described in detail.

The vinylidene fluoride polymer resin may include at least one of a vinylidene fluoride homopolymer and a vinylidene fluoride copolymer. Specifically, the vinylidene fluoride polymer resin may include at least one of ethylene tetrafluoride, propylene hexafluoride, ethylene trifluoride, and ethylene trifluoride chloride copolymers.

The vinylidene fluoride polymer resin may have a weight average molecular weight of about 100,000 to about 1,000,000, specifically about 250,000 to about 800,000, more specifically about 300,000 to about 600,000. Within this range, a membrane prepared using the composition can have good balance between mechanical strength and viscosity.

The vinylidene fluoride polymer resin may be present in an amount of about 8 wt %, 9 wt %, 10 wt %, 11 wt %, 12 wt %, 13 wt %, 14 wt %, 15 wt %, 16 wt %, 17 wt %, 18 wt %, 19 wt %, or 20 wt % in the membrane composition. In addition, the vinylidene fluoride polymer resin may be present in an amount ranging from one of the numerical values set forth above to another numerical value set forth above. For example, the vinylidene fluoride polymer resin may be present in an amount of about 8 wt % to less than about 20 wt %, specifically about 8 wt % to about 18 wt %, more specifically about 10 wt % to about 18 wt % in the membrane composition. Within this range, a membrane prepared using the composition can have good properties in terms of chemical resistance and strength.

The solvent serves to allow the vinylidene fluoride polymer resin to be sufficiently dissolved in the membrane composition and to impart viscosity required for preparation of a polymeric membrane.

For example, the solvent may include at least one selected from among dimethylacetamide (DMAc), dimethylformamide (DMF), n-methyl-pyrrolidone (NMP), n-octyl-pyrrolidone, n-phenyl-pyrrolidone, dimethyl sulfoxide (DMSO), chloroform, sulfolane, catechol, ethyl lactate, acetone, ethyl acetate, butyl carbitol, monoethanolamine, butyrolactone, diglycolamine, γ-butyrolactone, tetrahydrofuran (THF), methyl formate, diethyl ether, ethyl benzoate, acetonitrile, ethylene glycol, glycerol, dioxane, methylcarbitol, monoethanolamine, pyridine, propylene carbonate, toluene, decane, hexane, xylene, cyclohexane, 1H,1H,9H-perfluoro-1-nonanol, perfluoro-1,2-dimethylcyclobutane, perfluoro-1,2-dimethylcyclohexane, and perfluorohexane.

The solvent may be present in an amount of about 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, or 90 wt % in the membrane composition. In addition, the solvent may be present in an amount ranging from one of the numerical values set forth above to another numerical value set forth above. For example, the solvent may be present in an amount of more than about 60 wt % to about 90 wt %, specifically about 65 wt % to about 90 wt % in the membrane composition. Within this range, the polymer resin can be sufficiently dissolved in the membrane composition, thereby improving homogeneity of the composition.

The acetylated methyl cellulose serves to increase hydrophilicity and thus water permeability of a membrane without deterioration in chemical resistance and strength of the membrane, which are imparted by the vinylidene fluoride polymer resin. Specifically, the acetylated methyl cellulose has abundant hydrophilic hydroxyl groups and thus can improve hydrophilicity and water permeability of a membrane without deterioration in chemical resistance and strength of the membrane even when used in a small quantity.

The acetylated methyl cellulose may be present in an amount of about 0.1 wt %, 0.2 wt %, 0.3 wt %, 0.4 wt %, 0.5 wt %, 0.6 wt %, 0.7 wt %, 0.8 wt %, 0.9 wt %, 1.0 wt %, 1.5 wt %, 2.0 wt %, 2.5 wt %, 3.0 wt %, 3.5 wt %, 4.0 wt %, 4.5 wt %, or 5.0 wt % in the membrane composition. In addition, the acetylated methyl cellulose may be present in an amount ranging from one of the numerical values set forth above to another numerical value set forth above. For example, the acetylated methyl cellulose may be present in an amount of about 0.1 wt % to about 5 wt %, specifically about 0.1 wt % to about 3 wt %, more specifically about 0.1 wt % to about 2 wt % in the membrane composition. Within this range, a membrane prepared using the composition can have good water permeability.

The hydrophilic additive serves to further improve hydrophilicity and thus water treatment efficiency of a hollow fiber membrane.

For example, the hydrophilic additive may include at least one selected from among polyvinylpyrrolidone (PVP), ethylene glycol, polyethylene glycol (PEG), a hydrophilic polymer having at least one (meth)acrylate group, glycerol, polyacrylonitrile (PAN), polyethylene oxide (PEO), and polyvinyl acetate (PVAc).

The hydrophilic additive may be present in an amount of about 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, or 15 wt % in the membrane composition. In addition, the hydrophilic additive may be present in an amount ranging from one of the numerical values set forth above to another numerical value set forth above. For example, the hydrophilic additive may be present in an amount of about 1 wt % to about 15 wt %, specifically about 1 wt % to about 10 wt % in the membrane composition. Within this range, a membrane prepared using the composition can have good water permeability.

The membrane composition may further include an additional additive (other than the hydrophilic additive) in order to obtain desired properties of a membrane or to adjust the shape and size of pores formed in a surface or inside of a membrane. The additional additive may include any suitable additive, for example, a polyoxyethylene-polyoxypropylene block copolymer, lithium chloride (LiCl), lithium perchlorate (LiClO₄), methanol, ethanol, isopropanol, acetone, phosphoric acid, propionic acid, acetic acid, pyridine, and polyvinylpyridine. These may be used alone or as a mixture thereof The additional additive may be present in an amount of about 0.1 parts by weight to about 50 parts by weight, specifically about 1 part by weight to about 20 parts by weight, more specifically about 1 part by weight to about 10 parts by weight relative to 100 parts by weight of the membrane composition.

Method of Preparing Membrane

In accordance with another aspect of the present invention, a method of preparing a membrane includes: stirring the membrane composition as set forth above; forming a membrane in hollow fiber form by discharging the membrane composition through a spinning nozzle; and solidifying the membrane in hollow fiber form.

Stirring the membrane composition is performed to allow the components of the composition to be sufficiently dissolved and/or mixed in the solvent. Here, stirring may be carried out at about 40° C. to about 90° C., specifically about 50° C. to about 90° C. for about 4 to 7 hours. Within this range of stirring temperature, the components of the membrane composition can be sufficiently mixed together without damage or deterioration.

Discharging the membrane composition may be performed using a spinneret having an inner nozzle and an outer nozzle. Specifically, the membrane composition may be discharged through the outer nozzle, and an internal coagulant may be discharged through the inner nozzle. The internal coagulant discharged through the inner nozzle of the spinneret serves to form a hollow through the discharged membrane composition to obtain a membrane in hollow fiber form.

In other words, the internal coagulant serves to form an inner hole of a hollow fiber membrane and to determine internal morphology of the hollow fiber membrane. Generally, the internal coagulant may be a mixture of a solvent and non-solvent for polymers.

In one embodiment, the internal coagulant may include about 40 wt % to about 90 wt % of at least one solvent selected from among n-methylpyrrolidone and dimethylacetamide and the balance of a non-solvent based on the total weight of the internal coagulant. When the amounts of the solvent and the non-solvent fall within this range, it is possible to prevent damage to an inner surface of the hollow fiber membrane and reduction in porosity of the hollow fiber membrane. The non-solvent may include at least one selected from among water, ethylene glycol, an alcohol solvent, a ketone solvent, and polyalkylene glycol.

Solidification of the membrane in hollow fiber form may be performed by dipping the membrane in a coagulation bath containing at least one of a solvent and a non-solvent.

In other words, the membrane composition may be formed into a membrane through coagulation bath treatment. Specifically, the discharged membrane composition may be dipped in the non-solvent, thereby preparing a membrane having inner pores. The coagulation bath may contain a solvent and a non-solvent that does not dissolve a polymeric membrane.

For example, the solvent may include at least one selected from among dimethylacetamide (DMAc), dimethylformamide (DMF), n-methyl-pyrrolidone (NMP), n-octyl-pyrrolidone, n-phenyl-pyrrolidone, dimethyl sulfoxide (DMSO), chloroform, sulfolane, catechol, ethyl lactate, acetone, ethyl acetate, butyl carbitol, monoethanolamine, butyrolactone, diglycolamine, γ-butyrolactone, tetrahydrofuran (THF), methyl formate, diethyl ether, ethyl benzoate, acetonitrile, ethylene glycol, glycerol, dioxane, methylcarbitol, monoethanolamine, pyridine, propylene carbonate, toluene, decane, hexane, hexanes, xylenes, cyclohexane, 1H,1H,9H-perfluoro-1-nonanol, perfluoro-1,2-dimethylcyclobutane, perfluoro-1,2-dimethylcyclohexane, and perfluorohexane.

For example, the non-solvent may include various organic solvents, water, and glycols, specifically water or a coagulation solvent obtained by mixing water with an organic solvent or glycols, more specifically water. Here, the temperature of the coagulation solvent may range from about 0° C. to about 80° C., specifically about 5° C. to about 70° C., more specifically about 10° C. to about 60° C.

In another embodiment, the method may further include removing bubbles after stirring the membrane composition and before discharging the composition through the spinning nozzle. Removal of bubbles before discharge of the membrane composition can prevent undesirable formation of macro pores while allowing the composition to be uniformly mixed.

The method may further include washing and drying a resulting product of the solidification process. Specifically, the resulting product may be washed with a solvent which does not dissolve the resulting product and then dried at a predetermined temperature, thereby obtaining a final polymeric membrane. The solvent for washing may include acetone, methanol, ethanol, water, and the like, for example, water at about 20° C. to about 90° C. In addition, a resulting product of the washing process may be dried at about 20° C. to about 200° C., specifically about 40° C. to about 100° C., thereby finally obtaining a microporous polymeric membrane.

Membrane

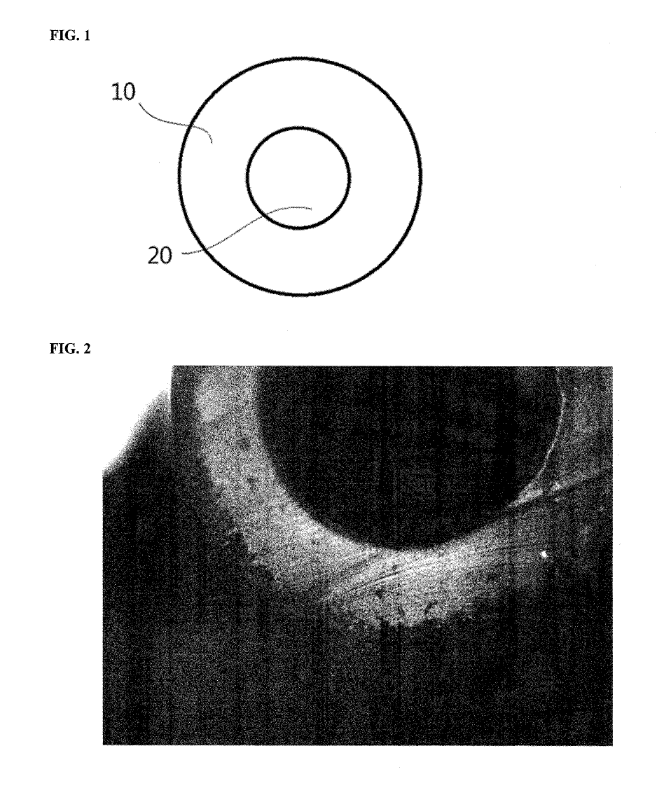

A membrane according to the present invention will be described in detail with reference to FIG. 1. FIG. 1 is a schematic sectional view of a membrane according to one embodiment of the present invention.

In accordance with a further aspect of the present invention, a membrane 10 may be formed of the membrane composition as set forth above. The membrane 10 may be a hollow fiber membrane having a central hollow 20. The hollow 20 serves as a moving path of treated water obtained by filtering raw water through the membrane 10.

The acetylated methyl cellulose included in the membrane has abundant hydrophilic groups and thus can improve hydrophilicity and water permeability of the membrane without deterioration in chemical resistance and strength of the membrane even when used in a small quantity.

In one embodiment, the membrane may have a water permeability of about 300 LMH/bar or more, specifically about 300 LMH/bar, 400 LMH/bar, 500 LMH/bar, 600

LMH/bar, 700 LMH/bar, 800 LMH/bar, 900 LMH/bar, 1,000 LMH/bar, 1,100 LMH/bar, 1,200 LMH/bar, 1,300 LMH/bar, 1,400 LMH/bar, 1,500 LMH/bar, 1,600 LMH/bar, 1,700 LMH/bar, 1,800 LMH/bar, 1,900 LMH/bar, or 2,000 LMH/bar. In addition, the membrane may have a water permeability ranging from one of the numerical values set forth above to another numerical value set forth above. For example, the membrane may have a water permeability of about 300 LMH/bar to about 2,000 LMH/bar, specifically about 350 LMH/bar to about 1,800 LMH/bar, more specifically about 400 LMH/bar to about 1,500 LMH/bar, even more specifically about 500 LMH/bar to about 1,500 LMH/bar.

The membrane may have a tensile strength of about 0.25 kgf/fil. or more, specifically about 0.25 kgf/fil., 0.3 kgf/fil., 0.4 kgf/fil., 0.5 kgf/fil., 0.6 kgf/fil., 0.7 kgf/fil., 0.8 kgf/fil., 0.9 kgf/fil., 1.0 kgf/fil., 1.5 kgf/fil., 2.0 kgf/fil., 2.5 kgf/fil., 3.0 kgf/fil., 3.5 kgf/fil., 4.0 kgf/fil., 4.5 kgf/fil., or 5.0 kgf/fil. In addition, the membrane may have a tensile strength ranging from one of the numerical values set forth above to another numerical value set forth above. For example, the membrane may have a tensile strength of about 0.25 kgf/fil. to about 5 kgf/fil., specifically about 0.25 kgf/fil. to about 3 kgf/fil., more specifically about 0.3 kgf/fil. to about 2 kgf/fil.

The membrane may have a maximum void size of less than about 200 um. Specifically, the membrane does not contain voids larger than a specific size and thus has good properties in terms of pressure resistance and strength. The membrane may not contain macro-voids having a size of about 200 μm or greater, specifically about 180 um or greater, more specifically about 150 μm to about 1,000 μm, even more specifically about 150 μm to about 500 μm.

The membrane may be prepared using a spinneret, without being limited thereto. The membrane prepared using the spinneret may be prepared in hollow fiber form.

Water Treatment Apparatus

In accordance with yet another aspect of the present invention, a water treatment apparatus may include the membrane as set forth above. Advantageously, the water treatment apparatus including the membrane has prolonged service life due to good pressure resistance and strength and exhibits good properties in terms of water permeability and water treatment efficiency.

Next, the present invention will be described in more detail with reference to some examples. However, it should be noted that these examples are provided for illustration only and are not to be construed in any way as limiting the present invention. In addition, descriptions of details apparent to those skilled in the art will be omitted for clarity.

### EXAMPLE

### Example 1

16 wt % of polyvinylidene difluoride (PVDF), 79.5 wt % of n-methylpyrrolidone

(NMP), 0.5 wt % of acetylated methyl cellulose (AMC) and 4 wt % of polyvinylpyrrolidone (PVP) were stirred at 50° C. for 6 hours to prepare a membrane composition, followed by removal of bubbles from the composition.

An internal coagulant was prepared by mixing 65 wt % of n-methyl-pyrrolidone with 35 wt % of polyethylene glycol.

The membrane composition and the internal coagulant were discharged to a coagulation bath containing water through an outer nozzle and inner nozzle of a spinneret, respectively, followed by solidification, thereby preparing a membrane.

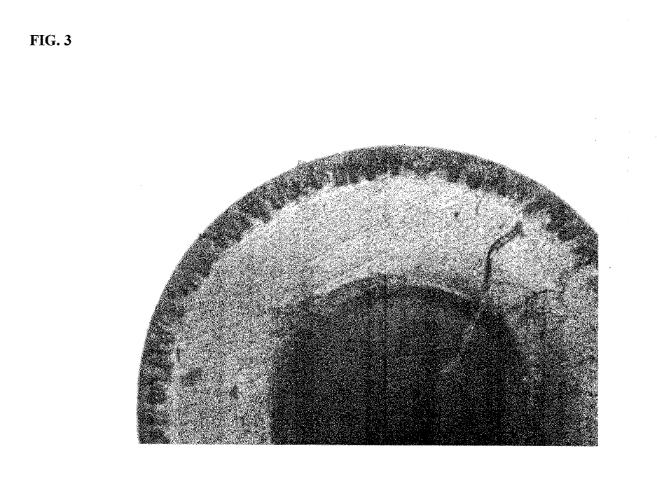

An electron micrograph (×100 magnification) of the prepared membrane is shown in FIG. 2.

### Comparative Example 1

A membrane was prepared in the same manner as in Example 1 except that acetylated methyl cellulose (AMC) was not used and the other components of the membrane composition were used in amounts as listed in Table 1.

A microscope image (×1,000 magnification) of the prepared membrane is shown in FIG. 3.

### Comparative Example 2

A membrane was prepared in the same manner as in Example 1 except that acetylated methyl cellulose (AMC) was used in an amount of 7 wt % and the other to components of the membrane composition were used in amounts as listed in Table 1.

### Comparative Example 3

A membrane was prepared in the same manner as in Example 1 except that polyvinylidene difluoride (PVDF) was used in an amount of 20 wt % and the other components of the composition were used in amounts as listed in Table 1.

Property Evaluation

(1) Water permeability (LMH): A hollow fiber membrane was placed in a 20 mm acrylic tube and potted with an epoxy resin, followed by measurement of a net permeate flow rate per hour, thereby determining water permeability per unit membrane area. Results are shown in Table 1. Here, the net water permeability was measured by dead-end filtration through application of a pressure of 1 bar.

(2) Tensile strength (gf/fil.): Tensile strength was measured using an Instron testing machine. In measurement, one strand of a hollow fiber membrane was held by a gripper (distance between fingers: 50 mm) and pulled at a rate of 100 mm/min. Results are shown in Table 1.

(3) Maximum void size (unit: um): A hollow fiber membrane was mounted on a stage of an optical microscope with a cut section of the hollow fiber membrane facing upward and then observed at a magnification of 100 to measure lengths of voids from an outer circumferential surface of the membrane. Results are shown in Table 1.

TABLE 1

| | | Compar- | Compar- | Compar- |
|---|---|---|---|---|
| | | ative | ative | ative |
| | Example | Example | Example | Example |
| | 1 | 1 | 2 | 3 |
| PVDF (wt %) | 16 | 16 | 16 | 20 |
| NMP (wt %) | 79.5 | 80 | 73 | 75.5 |
| AMC (wt %) | 0.5 | 0 | 7 | 0.5 |
| PVP (wt %) | 4 | 4 | 4 | 4 |
| Water permeability | 620 | 440 | — | 228 |
| (LMH) | | | | |
| Tensile strength | 0.33 | 0.24 | — | 0.38 |
| (kgf/fil.) | | | | |
| Maximum | 130 | 215 | — | 170 |
| void size (unit: μm) | | | | |

As shown in Table 1, it can be seen that the membrane of Example 1 including acetylated methyl cellulose (AMC) in an amount according to the present invention had good properties in terms of water permeability and tensile strength and did not contain voids having a size of 200 μm or greater. Conversely, it can be seen that the membrane of Comparative Example 1 not including acetylated methyl cellulose (AMC) had poor water permeability due to low hydrophilicity and contained macro-voids having a size of 200 μm or greater and thus exhibited poor tensile strength, and the membrane of Comparative Example 2 including an excess of acetylated methyl cellulose (AMC) was not measurable in water permeability, tensile strength, and maximum void size due to incomplete polymer dissolution. In addition, it can be seen that the membrane of Comparative Example 3 including 20 wt % of a vinylidene fluoride polymer resin exhibited considerably poor water permeability.

Although some embodiments have been described herein, it should be understood by those skilled in the art that these embodiments are given by way of illustration only and the present invention is not limited thereto. In addition, it should be understood that various modifications, variations, and alterations can be made by those skilled in the art without departing from the spirit and scope of the present invention. Therefore, the scope of the invention should be limited only by the accompanying claims and equivalents thereof

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used alone or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A membrane composition, comprising:
about 8 wt % to less than about 20 wt % of a vinylidene fluoride polymer resin;
more than 60 wt % to about 90 wt % of a solvent;
about 0.1 wt % to about 5 wt % of acetylated methyl cellulose; and
about 1 wt % to about 15 wt % of a hydrophilic additive.

2. The membrane composition according to claim 1, wherein the solvent comprises at least one selected from among dimethylacetamide (DMAc), dimethylformamide (DMF), n-methyl-pyrrolidone (NMP), n-octyl-pyrrolidone, n-phenyl-pyrrolidone, dimethyl sulfoxide (DMSO), chloroform, sulfolane, catechol, ethyl lactate, acetone, ethyl acetate, butyl carbitol, monoethanolamine, butyrolactone, diglycolamine, γ-butyrolactone, tetrahydrofuran (THF), methyl formate, diethyl ether, ethyl benzoate, acetonitrile, ethylene glycol, glycerol, dioxane, methylcarbitol, monoethanolamine, pyridine, propylene carbonate, toluene, decane, hexanes, xylenes, cyclohexane, 1H,1H,9H-perfluoro-1 -nonanol, perfluoro-1,2-dimethylcyclobutane, perfluoro-1,2-dimethylcyclohexane, and perfluorohexane.

3. The membrane composition according to claim 1, wherein the hydrophilic additive comprises at least one selected from among polyvinylpyrrolidone (PVP), ethylene glycol, polyethylene glycol (PEG), a hydrophilic polymer having at least one (meth)acrylate group, glycerol, polyacrylonitrile (PAN), polyethylene oxide (PEO), and polyvinyl acetate (PVAc).

4. A membrane prepared using the membrane composition according to claim 1, wherein the membrane has a water permeability of about 300 LMH/bar or more and a tensile strength of about 0.25 kgf/fil. or more.

5. The membrane according to claim 4, wherein the membrane is prepared in hollow fiber form.

6. The membrane according to claim 4, wherein the membrane has a void size of less than about 200 μm.

7. A water treatment apparatus comprising the membrane according to claim 4.
